(19) United States
(12) Patent Application Publication
(10) Pub. No.: US 2024/0169186 A1
(43) Pub. Date: May 23, 2024

(54) Machine-Learned Models for User Interface Prediction and Generation

(71) Applicant: Google LLC, Mountain View, CA (US)

(72) Inventors: Xiaoxue Zang, Santa Clara, CA (US); Ying Xu, Bellevue, WA (US); Srinivas Kumar Sunkara, Mountain View, CA (US); Abhinav Kumar Rastogi, Sunnyvale, CA (US); Jindong Chen, Hillsborough, CA (US); Blaise Aguera-Arcas, Seattle, WA (US); Chongyang Bai, West Lebanon, NH (US)

(21) Appl. No.: 18/550,203

(22) PCT Filed: Jun. 2, 2021
(86) PCT No.: PCT/US2021/035510

§ 371 Date: Sep. 12, 2023

(51) Int. Cl. G06N 3/0455; G06N 3/084

(52) U.S. Cl. CPC G06N 3/0455; G06N 3/084

(57) ABSTRACT

Generally, the present disclosure is directed to user interface understanding. More particularly, the present disclosure relates to training and utilization of machine-learned models for user interface prediction and/or generation. A machine-learned interface Nprediction model can be pre-trained using a variety of pre-training tasks for eventual downstream task training and utilization (e.g., interface prediction, interface generation, etc.).

### FIELD

The present disclosure relates generally to user interface understanding. More particularly, the present disclosure relates to training and utilization of machine-learned models for user interface prediction and/or generation.

### BACKGROUND

To improve the accessibility of smart devices and simplify their usage, building intuitive, efficient user interfaces that can assist users in completing their tasks is critical. However, interface-specific characteristics have conventionally made machine learning techniques prohibitively difficult to apply. For example, conventional machine learning techniques struggle to effectively leverage multimodal interface features that involve image, text, and/or structural metadata. For another example, it is conventionally difficult for machine-learned models to achieve strong performance when high-quality labeled data is unavailable — as is common with user interfaces. As such, machine-learned models capable of efficient and accurate user interface prediction and/or generation are strongly desired.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for training and utilization of machine-learned models for user interface prediction. The method includes obtaining, by a computing system comprising one or more computing devices, interface data descriptive of a single user interface comprising a plurality of interface elements, wherein the interface data comprises one or more interface images depicting the single user interface. The method includes determining, by the computing system, a plurality of intermediate embeddings based at least in part on one or more of the one or more interface images or textual content depicted in the one or more interface images. The method includes processing, by the computing system, the plurality of intermediate embeddings with a machine-learned interface prediction model to obtain one or more user interface embeddings. The method includes performing, by the computing system, a pre-training task based at least in part on the one or more user interface embeddings to obtain a pre-training output.

Another example aspect of the present disclosure is directed to a computing system that includes one or more processors and one or more tangible, non-transitory computer readable media storing computer-readable instructions that store a machine-learned interface prediction model configured to generate learned representations for user interfaces. The machine-learned interface prediction model has been trained by performance of operations. The operations include obtaining interface data descriptive of a single user interface comprising a plurality of interface elements, wherein the interface data comprises an interface image depicting the single user interface. The operations include determining a plurality of intermediate embeddings based at least in part on one or more of the one or more interface images or textual content depicted in the one or more interface images. The operations include processing the plurality of intermediate embeddings with a machine-learned interface prediction model to obtain one or more user interface embeddings. The operations include performing a pre-training task based at least in part on the one or more user interface embeddings to obtain a pre-training output.

Another example aspect of the present disclosure is directed to one or more tangible, non-transitory computer readable media storing computer-readable instructions that when executed by one or more processors cause the one or more processors to perform operations. The operations include obtaining interface data descriptive of a single user interface comprising a plurality of interface elements, wherein the interface data comprises structural data and an interface image depicting the single user interface, wherein the structural data is indicative of one or more positions of one or more respective interface elements of the plurality of interface elements. The operations include determining a plurality of intermediate embeddings based at least in part on one or more of the structural data, the one or more interface images, or textual content depicted in the one or more interface images. The operations include processing the plurality of intermediate embeddings with a machine-learned interface prediction model to obtain one or more user interface embeddings. The operations include performing a pre-training task based at least in part on the one or more user interface embeddings to obtain a pre-training output.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs training and utilization of machine-learned interface prediction models according to example embodiments of the present disclosure.

FIG. 1B depicts a block diagram of an example computing device that performs pre-training of a machine-learned interface prediction model according to example embodiments of the present disclosure.

FIG. 1C depicts a block diagram of an example computing device that performs interface prediction with a machine-learned interface prediction model according to example embodiments of the present disclosure.

FIG. 2 depicts a block diagram of an example machine-learned interface prediction model according to example embodiments of the present disclosure.

FIG. 3 depicts a block diagram of an example machine-learned interface prediction model according to example embodiments of the present disclosure.

FIG. 4 depicts an example diagram of a user interface according to example embodiments of the present disclosure.

FIG. 5 depicts a data flow diagram for performing pre-training tasks with a machine-learned interface prediction model.

FIG. 6 depicts a flow chart diagram of an example method to perform pre-training of a machine-learned interface prediction model according to example embodiments of the present disclosure.

Reference numerals that are repeated across plural figures are intended to identify the same features in various implementations.

### DETAILED DESCRIPTION

### Overview

Generally, the present disclosure is directed to user interface understanding. More particularly, the present disclosure relates to training and utilization of machine-learned models for user interface prediction and/or generation. As an example, interface data descriptive of a user interface can be obtained (e.g., a user interface presented by an application and/or operating system, etc.). The user interface can include a plurality of user interface elements (e.g., icon(s), interactable button(s), image(s), textual content, etc.). The interface data can include structural data (e.g., metadata indicative of the position(s) of interface element(s), etc.) and an interface image that depicts the user interface. A plurality of intermediate embeddings can be determined based on the structural data, the one or more interface images, and/or textual content depicted in the one or more interface images (e.g., using text recognition models (OCR), etc.). These intermediate embeddings can be processed with a machine-learned interface prediction model to obtain one or more user interface embeddings. Based on the one or more user interface embeddings, a pre-training task can be performed to obtain a pre-training output. In such fashion, the machine-learned interface prediction model can be pre-trained using a variety of pre-training tasks for eventual downstream task training and utilization (e.g., interface prediction, interface generation, etc.).

More particularly, interface data can be obtained that describes a user interface. The user interface can be a user interface associated with an application and/or operating system of a computing device. As an example, the user interface may be a main menu interface for a food delivery application. As another example, the user interface may be a lock screen interface for a smartphone device. As yet another example, the user interface may be a home screen interface for a virtual assistant device or a video game console. As such, it should be broadly understood that the user interface may be any type of interface for any sort of device and/or application.

The user interface can include a plurality of interface elements. The interface elements can include icon(s), interactable element(s) (e.g., buttons, etc.), indicator(s), etc. As an example, an interface element can be or otherwise include an interactable element that navigates to a second user interface when selected by a user (e.g., using a touch gesture on a touch screen device, etc.). As another example, an interface element can be or otherwise include an input field that is configured to accept user input (e.g., via a virtual on-screen keyboard, etc.). As yet another example, an interface element can be or otherwise include an icon descriptive of function(s) of a smartphone device that the user interface is displayed by (e.g., a connectivity indication icon, a battery life icon, etc.). As such, it should be broadly understood that the plurality of interface elements can include any discrete functional unit or portion of the user interface.

The interface data can include structural data. The structural data can indicate one or more positions of one or more interface elements of the plurality of interface elements. As an example, the structural data can indicate a size and position of an icon interface element within the user interface when presented. As another example, the structural data can indicate or otherwise dictate various characteristics of an input field interface element (e.g., font, text size, field size, field position, feedback characteristics (e.g., initiating a force feedback action when receiving input from a user, playing sound(s) when receiving input from a user, etc.), functionality between other application(s) (e.g., allowing use of virtual keyboard application(s), etc.), etc.).

In some implementations, the structural data can be or otherwise include view hierarchy data. As used herein, the term “view hierarchy data” can refer to data descriptive of a View Hierarchy and/or data descriptive of a Document Object Model. The view hierarchy data can include a tree representation of the UI elements. Each node of the tree can describe certain attributes (e.g. bounding box positions, functions, etc.) of an interface element. As an example, the view hierarchy tree of the structural data can include textual content data associated with visible text of textual interface element(s) included in the user interface. As another example, the view hierarchy tree of the structural data can include content descriptor(s) and/or resource-id(s) that can describe functionality (e.g. interface navigation path(s), sharing functionality, etc.) which is generally not provided to users. As another example, the view hierarchy tree of the structural data can include class name data descriptive of function class(es) of application programming interface(s) and/or software tool(s) associated with implementation of the corresponding interface element. As another example, bounding data can denote an interface element's bounding box location within the user interface. It should be noted that, in some implementations, various types of data (e.g., textual content data, etc.) can be empty within the view hierarchy data.

More particularly, in some implementations the structural data can be or otherwise include view hierarchy leaf nodes of view hierarchy tree data. For each leaf node, the content of the nodes' textual fields can be encoded into feature vectors (e.g., text, content descriptor(s), resource ID(s), class name(s), etc.). In some implementations, as a preprocessing step, the content of the class name data can be normalized by heuristics to one of a discrete number of classes. Additionally, or alternatively, in some implementations, as a preprocessing step, the content of resource ID data can be split by underscores and camel cases. The normalized class name data can be encoded as a one-hot embedding, while the content of other fields can be processed to obtain their sentence-level embeddings.

Additionally, the interface data can include an interface image that depicts the user interface. For example, the one or more interface images can be an image captured as the user interface is displayed on a display device (e.g., capturing using a camera device, a screen capture application, etc.). Additionally, the one or more interface images can depict textual content. As an example, the user interface can be a home screen interface for a smartphone device with textual content that includes text. The text can be recognized (e.g., using optical character recognition model(s), etc.) to obtain the textual content.

In some implementations, the interface data can be descriptive of only a single user interface (e.g., as opposed to multiple user interfaces, such as a sequence of user interfaces). By providing data from only a single user interface, the models described herein can be forced to learn representations for user interfaces in a static nature (e.g., without the benefit or context of changes (e.g., visual changes) between user interfaces). This can result in more powerful models which are able to understand the functionality of a user interface simply by viewing data from a single instance or image and therefore do not require multiple instances or images which demonstrate the functionality via different interface iterations.

Based at least in part on the structural data, the one or more interface images, and/or textual content depicted in the one or more interface images, a plurality of intermediate embeddings can be determined. In some implementations, the intermediate embeddings can be or otherwise include one or more image embeddings, one or more textual embeddings, one or more positional embeddings, and/or one or more content embeddings. As an example, features extracted from the interface data can be linearly projected to obtain the plurality of intermediate embeddings Cᵢ [symbol] ^{d}, for every iₜₕ input with type (i) ∈ {IMG, OCR, VH} and use 0s for the inputs of other types.

More particularly, in some implementations, the one or more positional embeddings can be determined from the structural data. The one or more positional embeddings can correspond to the one or more positions of the one or more respective interface elements. As an example, the location feature of each interface element can be encoded using its bounding box (e.g., as described by the structural data, etc.), which can include normalized top-left, bottom-right point coordinates, width, height, and/or the area of the bounding box. For example, a linear layer can be used to project the location feature to the positional embedding, Pᵢ ∈ [symbol] ^{d}, for the iₜₕ component (Pᵢ=0 for CLS and SEP).

In some implementations, the one or more image embeddings can be determined from the one or more interface images. The one or more image embeddings can be respectively associated with at least one interface element of the plurality of interface elements. As an example, one or more portions of the one or more interface images can be determined from the one or more interface images (e.g., based on the bounding boxes described by the structural data, etc.). A machine-learned model (e.g., the machine-learned interface prediction model, etc.) can process the portion(s) of the one or more interface images to obtain the respective one or more image embeddings (e.g., using a last spatial average pooling layer, etc.).

In some implementations, the plurality of intermediate embeddings can include one or more type embeddings. The one or more type embeddings can respectively indicate a type of embedding for each of the other embeddings of the plurality of intermediate embeddings. As an example, to distinguish the various portions of the interface data, six type tokens can be utilized: IMG, OCR, VH, CLS, SEP, and MASK. In some implementations, the MASK token can be a type of token utilized to increase pre-training accuracy for the machine-learned interface prediction model. For example, a one-hot encoding followed by linear projection can be used to obtain a type embedding, Tᵢ ∈ [symbol] ^{d}, for the iₜₕ component in the sequence where d is the dimension size.

In some implementations, the plurality of intermediate embeddings can be determined by processing the structural data, the one or more interface images, and/or textual content depicted in the one or more interface images with an embedding portion of the machine-learned interface prediction model to obtain the plurality of intermediate embeddings. For example, the interface data (e.g., the structural data, the one or more interface images, etc.), can be input to the embedding portion to obtain the intermediate embeddings, which can then be processed with a separate portion of the machine-learned interface prediction model (e.g., a transformer portion, etc.) to obtain the one or more user interface embeddings.

The plurality of intermediate embeddings can be processed with the machine-learned interface prediction model to obtain one or more user interface embeddings. More particularly, each of the types of intermediate embeddings can be summed, and can be processed by the machine-learned interface prediction model. In some implementations, a transformer portion of the machine-learned interface prediction model can process the intermediate embeddings to obtain the one or more user interface embeddings. For example, the machine-learned interface prediction model (e.g., the transformer portion of the machine- learned interface prediction model , etc.) can process the summated intermediate embeddings to obtain one or more user interface embeddings U ∈ [symbol] ^{n×d} as represented by:

U=TransformerEncoder(T+P+C), (1)

where T, P, C ∈ [symbol] ^{n×d} and n is the sequence length.

Based at least in part on the one or more user interface embeddings, a pre-training task can be performed. In some implementations, a loss function can be evaluated that evaluates a difference between ground truth data and the pre-training output. As an example, the ground truth data can describe an optimal prediction based on a masked input to the machine-learned interface prediction model. In some implementations, one or more parameters of the machine-learned interface prediction model can be adjusted based at least in part on the loss function (e.g., parameters of the transformer function and/or the embedding portion of the model). In such fashion, pre-training tasks can be used to train the machine-learned interface prediction to provide superior or more useful representations (e.g., user interface embeddings) for given input interface data.

In some implementations, the pre-training task can be or otherwise include an interface prediction task. For example, prior to determining the plurality of intermediate embeddings, one or more of the plurality of interface elements can be replaced with one or more respective second interface elements of a second user interface that is different than the user interface. More particularly, as an example, given an original interface A, a “fake” version of the interface A′ can be generated by replacing 20% of its interface elements of interface A with components from an interface B, which can be an interface randomly selected from a plurality of user interfaces included in a batch of training data. In some implementations, for each interface, the input to be replaced can be randomly selected (e.g., the one or more interface images, the structural data, the textual content from the one or more interface images, etc.). As an example, two portions of the one or more interface images from an interface A can be replaced by two portions of an interface image from an interface B to obtain a “fake” interface A′. It should be noted that in this example, the structural data and textual content are not replaced before input to the transformer portion of the machine-learned interface prediction model to minimize the difference between the original interface A and the “fake” interface A′, therefore increasing the difficulty of the task.

To follow the previous example, the interface prediction task can be performed with the machine-learned interface prediction model to obtain the pre-training output. The pre-training output can be configured to indicate whether the user interfaces A and A′ are real interfaces. For example, the pre-training output can predict whether each interface is real by minimizing the cross-entropy (CE) objective:

L_{RUI}=CE(y, ŷ) , (2)

where y is the binary label for UI x (y=1 if x is real), and ŷ=Sigmoid(FC(U_{CLS})) is the prediction probability. U_{CLS} can correspond to the output embedding of CLS token(s), and FC can represent a fully connected layer.

In some implementations, the pre-training output can be further configured to indicate whether each of the plurality of interface elements is an unmodified interface element. As an example, the pre-training output can be configured to predict, for every “fake” interface, whether an interface element of the interface is a “real” element of the respective interface. To follow the previous example, for the “fake” interface A′, two portions of the one or more interface images can be replace with portions of the one or more interface images from interface B, while the structural data remains the same as the original interface A. Intuitively, the content of a “fake” interface element would not align with the rest of the interface elements. Thus, the machine-learned interface prediction model is only required to learn from the context to make the correct prediction. For example, the objective of the pre-training task can be the sum of the weighted cross-entropy loss over all UI components in a fake UI:

L_{RCP}=Σ_{type(i)∈{IMG,OCR,VH}} CE(yᵢŷᵢ; λ) , (3)

where yᵢ is the label of the iₜₕ component, and ŷᵢ is the prediction made by a linear layer connected to the UI embedding Uᵢ. The weight A can be multiplied by the loss for “fake” interface elements to address any type of label imbalance (e.g., λ=2, etc.).

In some implementations, the pre-training task can be an image prediction task. As an example, prior to determining the plurality of intermediate embeddings, one or more portions of the one or more interface images can be masked. The pre-training task can be performed by processing the one or more user interface embeddings with the machine-learned interface prediction model or a separate pre-training prediction head to obtain the pre-training output, which can include a prediction for the one or more portions of the one or more interface images. The separate pre-training prediction head can be a small prediction component such as a linear model, a multi-layer-perceptron, or similar.

More particularly, as an example, a portion of the one or more interface images (e.g., 15% of the image, etc.) can be masked (e.g., replacing associated intermediate embeddings with Os and its type feature with MASK, etc.). The pre-training task can be configured to infer the masked portions of the one or more interface images from surrounding inputs for the user interface. Conventionally, approaches to interface image prediction rely on predicting either the object class (e.g. tree, sky, car, etc.) or object features of the masked image portions, which can be obtained by a pre-trained object detector. However, such methods highly rely on the accuracy of the pretrained object detector and are therefore unsuitable for the training of machine-learned interface prediction models. As such, systems and methods of the present disclosure instead endeavor to predict the masked image portions in a contrastive learning manner. For example, given an embedding of the one or more interface images portion alongside additional embedding(s) for some negative image portions (e.g., dissimilar portions, etc.) sampled from the same user interface, the output embedding of the masked positive can be expected to be closest to its embedding in terms of their cosine similarity scores. For example, let [symbol] _{IMG} be the set of masked image indices in a “real” user interface. A loss can be employed (e.g., a softmax version of Noise Contrastive Estimation (NCE) loss, etc.) as the objective:

$${L}_{MIP} = - {\sum }_{i ∈ {ℳ}_{IMG}} log NCE ( i \vert 𝒩 ( i ) ) , - 1 mm \qquad ( 4 )$$

$$- 1 mmNCE ( i \vert 𝒩 ( i ) ) = \frac{exp ( {U}_{i}^{T} {C}_{i} )}{exp ( {U}_{i}^{T} {C}_{i} ) + {\sum }_{j ∈ 𝒩 ( i )} exp ( {U}_{i}^{T} {C}_{j} )} , \qquad ( 5 )$$

where [symbol] (i) can represent the set of negative IMG components for i. In some implementations, the k closest image portions to the masked portions i in the image can be utilized as the “negative” image portions.

In some implementations, prior to determining the plurality of intermediate embeddings, one or more portions of the textual content depicted in the one or more interface images can be masked. Additionally, in some implementations, performing the pre-training task can include processing the one or more user interface embeddings with the machine-learned interface prediction model or a separate pre-training prediction head to obtain the pre-training output. As a more particular example, when masking the one or more portions of textual content, as each OCR component is a sequence of words, the prediction of the masked textual content can be framed as a generation problem. For example, a 1-layer GRU decoder can obtain the user interface embedding(s) associated with the masked textual content portion(s) as input to generate a prediction of unmasked portion(s) of textual content. As the goal of the pre-training task is to learn powerful interface embeddings, a simple decoder model or model portion can be utilized in some implementations.

Additionally, or alternatively, in some implementations, since it can be difficult to generate an entire sequence, tokens associated with masked portions of textual content can be masked with a certain probability (e.g., 15% chance, etc,). For example, only a portion of textual content including the word “restaurants” may be masked when the complete textual content includes the words “restaurants for families”. As an example, denote tᵢ=(t_{i,1}, . . . t_{i,n}_{ᵢ}) as the tokens of textual content portion i where t_{i,j}, ∀j is the one-hot encoding of the jth token, and \hat{t}ᵢ=GRU(Uᵢ)=(\hat{t}_{i,1}, . . . \hat{t}_{i,n}_{ᵢ}) as the predicted probability of the generated tokens, the MOG objective is framed as the sum of multi-class cross-entropy losses between the masked tokens and generated ones:

L_{MOG}=Σ_{(i,j)∈} [symbol] _{_{OCR}} CE(t_{i,j}, \hat{t}_{i,j}),−1 mm (6)

where [symbol] _{OCR} denotes the set of (component id, token id) pairs of the masked OCRs

In some implementations, prior to determining the plurality of intermediate embeddings, one or more portions of the structural data can be masked. As an example, a content description field included in the structural data that is associated with an interface element may be masked. As another example, a class name field included in the structural data that is associated with an interface element may be masked.

In some implementations, the one or more portions of the structural data that are masked can describe one or more class labels for one or more respective interface elements. Performing the pre-training task can include processing the one or more user interface embeddings with the machine-learned interface prediction model or a separate pre-training prediction head to obtain the pre-training output. The pre-training output can include one or more predicted class labels for the one or more respective class interfaces.

Alternatively, or additionally, in some implementations, the one or more masked portions of the structural data can further include one or more content descriptors for one or more respective interface elements of the plurality of interface elements. Performing the pre-training task can include processing the one or more user interface embeddings with the machine-learned interface prediction model or a separate pre-training prediction head to obtain the pre-training output. The pre-training output can include one or more predicted content descriptors for the one or more respective interface elements.

As a more particular example, for portions of the structural data (e.g., view hierarchy data, etc.), it is generally observed that masking of content descriptor(s) and class label(s) can be particularly effective. For each masked portion of the structural data that includes a content descriptor, a predicted content descriptor can be generated using a simple decoder. Additionally, for each masked portion of the structural data that includes a class label a predicted class label can be predicted using a fully connected layer with a softmax activation. For example:

L_{MVG}=Σ_{i∈} [symbol] _{_{VH}} (CE(cᵢ, ĉᵢ)+Σⱼ CE(t_{i,j}, \hat{t}_{i,j})),−1 mm (7)

where [symbol] _{VH} can represent the set of masked portions of the structural data, cᵢ can represent the one-hot encoding of a class label i, ĉᵢ=Softmax(FC(Uᵢ)) can represent the predicted probability vector, and t_{i,j}, \hat{t}_{i,j} can represent the original and predicted content descriptor(s) (e.g., content descriptor tokens, etc.). In some implementations, this can be performed in a substantially similar manner as to that previously described with regards to prediction of textual content. As such, in some implementations, the pre-training loss function for all of the task(s) can be defined as:

L =LRUI l{y=0}1,Rcp l{y=1}(LMIP LMOG LMVG), (8)

where 1_{{.}} is the indicator function.

In some implementations, one or more prediction tasks can be performed with the machine-learned interface prediction model based at least in part on the one or more user interface embeddings to obtain one or more respective interface prediction outputs. In some implementations, the one or more prediction tasks can include a search task, and the one or more prediction outputs can include a search retrieval output descriptive of one or more retrieved interface elements similar to a query interface element from the plurality of interface elements. As an example, given the user interface and an interface component of the user interface as a query, and a separate search user interface with a set of candidate interface elements, one or more retrieved elements closest to the query interface element can be selected based on various characteristic(s) of the interface element(s) (e.g., position, functionality, class label, content descriptor, appearance, dimensionality, etc.).

In some implementations, the one or more prediction tasks can include a relationship prediction task, and the corresponding prediction output can indicate a relationship between a portion of the structural data and an interface element of the plurality of interface elements. As an example, given a portion of the structural data (e.g., descriptive text presentable to a user that describes the functionality of an interface element, etc.), and the one or more interface images (e.g., and/or embeddings associated with the one or more interface images, etc.), an prediction output can be obtained that indicates a relationship between the portion of structural data and an interface element from the plurality of interface elements. As an example, the portion of structural data may include descriptive text for presentation to a user that includes the words “click this button to go back”, and the interface element can be a conventional “back” arrow. The prediction element can be obtained with the machine-learned interface prediction model. For example, the portion of structural data can be processed as an OCR component (e.g., recognized textual content, etc.), and the plurality of candidate interface elements can be processed as image portions that the machine-learned interface prediction model can take as input. Dot products of the output embedding of the portion of structural data and the output embeddings of the candidate interface elements can be computed as their similarity scores to obtain the prediction output indicative of the relationship between the portion of structural data and the portion of image data.

In some implementations, the one or more prediction tasks can include a structural-image sync prediction task, and the prediction output can include a correspondence value for the structural data and the one or more interface images. As an example, the machine-learned interface prediction model can process the one or more interface images and the structural data to obtain the prediction output. The prediction output can indicate whether the structural data matches the one or more interface images (e.g., whether the structural data describes positions of interface elements included in the one or more interface images, etc.). More particularly, user interface embedding(s) associated with the CLS tokens can be followed by a one-layer projection to predict a correspondence value indicative of whether the image and the structural data of the user interface are synced. In such fashion, this predictive task can, in some implementations, serve as a pre-processing step to filter out undesirable user interfaces.

In some implementations, the one or more prediction tasks can include an application classification task, and the corresponding prediction output can indicate an application category for an application associated with the user interface. As an example, the application classification task can predict a category of an application (e.g. music, finance, etc.) for the user interface. For example, there can be a plurality of candidate application categories to select from. A one-layer projection layer can be utilized to project the one or more user interface embeddings to one of the application categories of the plurality of application categories (e.g., the output of CLS component(s) and a concatenation of the one or more user interface embeddings, etc.). It should be noted that the predictive power of the application classification task is generally found to be exceedingly accurate in comparison to conventional methods due to the attention mechanisms of the transformer portion of the machine-learned interface prediction model and the extensive pre-training performed as described previously.

In some implementations, the one or more prediction tasks can include an interface element classification task, and the corresponding interface prediction output can include a classification output indicative of an interface element category for an interface element of the plurality of interface elements (e.g., a navigation element, an interactable element, a descriptive element, a type of element, etc.). As an example, the interface element classification task can identify the category of icon interface elements (e.g. menu, backward, search, etc.), which can be utilized for applications such as screen readers. To classify the category of an interface element, the user interface embedding(s) associated with an interface element's corresponding interface image portion(s) and structural data portion(s) can be concatenated and processed with a fully connected layer.

Systems and methods of the present disclosure provide a number of technical effects and benefits. As one example technical effect and benefit, the ability to quickly and efficiently navigate user interfaces is necessary for operation of many modern computing devices. However, a subset of users with certain disabilities (e.g., visual impairment, paralysis, etc.) cannot navigate user interfaces conventionally, and instead rely on accessibility solutions (e.g., screen readers, etc.). Conventionally, these accessibility solutions lack the capacity to understand or otherwise infer the functionality of user interfaces. As such, by training machine-learned model(s) for user interface prediction, generation, and general understanding, systems and methods of the present disclosure provide for a substantial increase in efficiency and accuracy in accessibility solutions for disabled users.

With reference now to the Figures, example embodiments of the present disclosure will be discussed in further detail.

### Example Devices and Systems

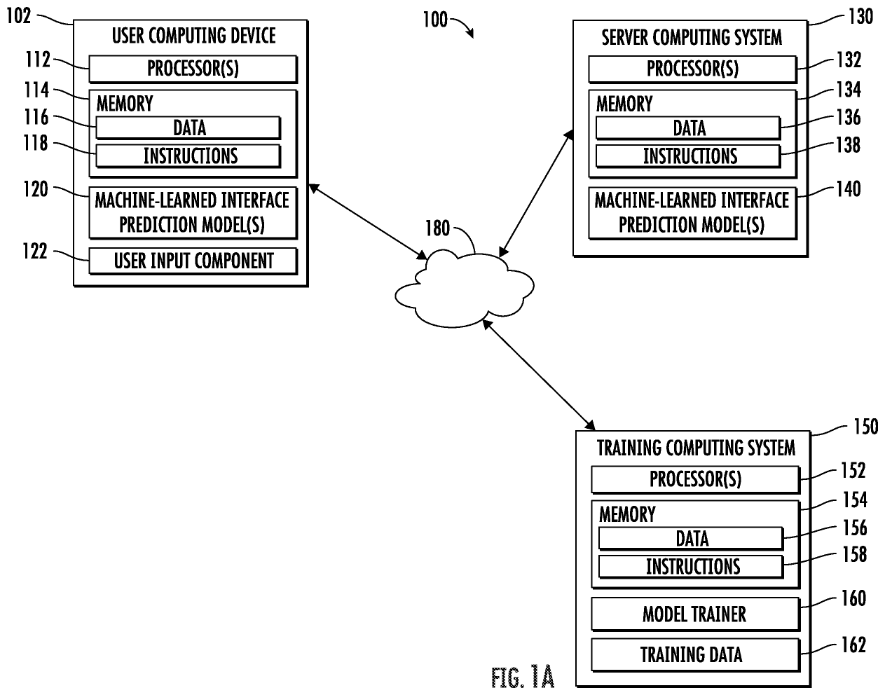

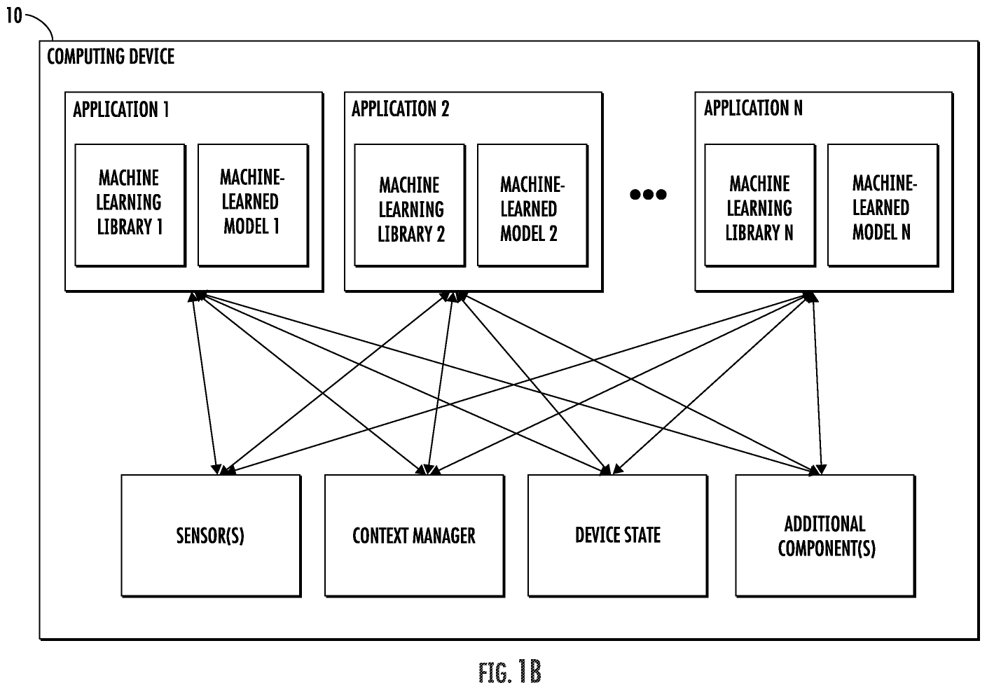

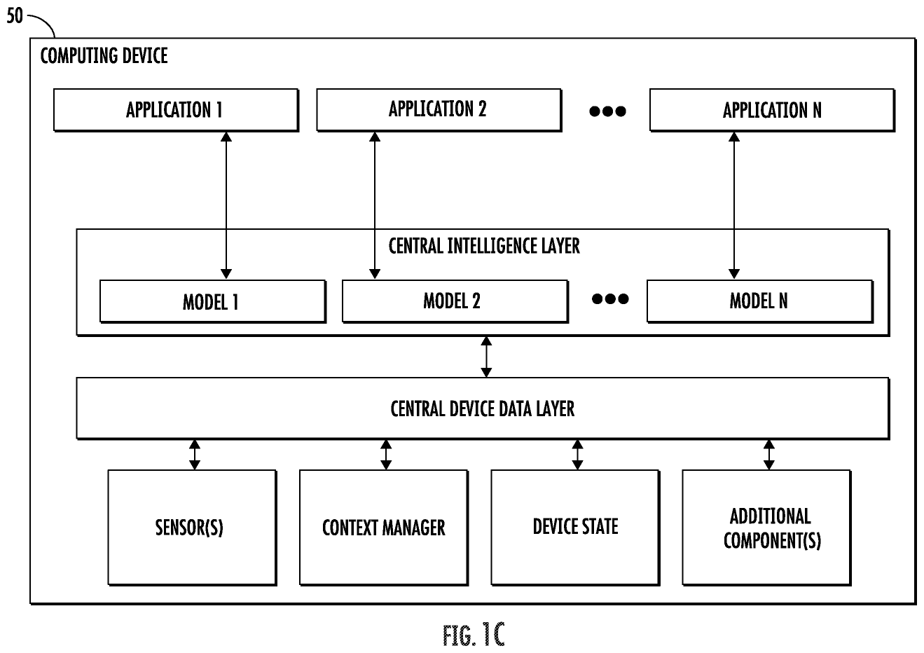

FIG. 1A depicts a block diagram of an example computing system 100 that performs training and utilization of machine-learned interface prediction models according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

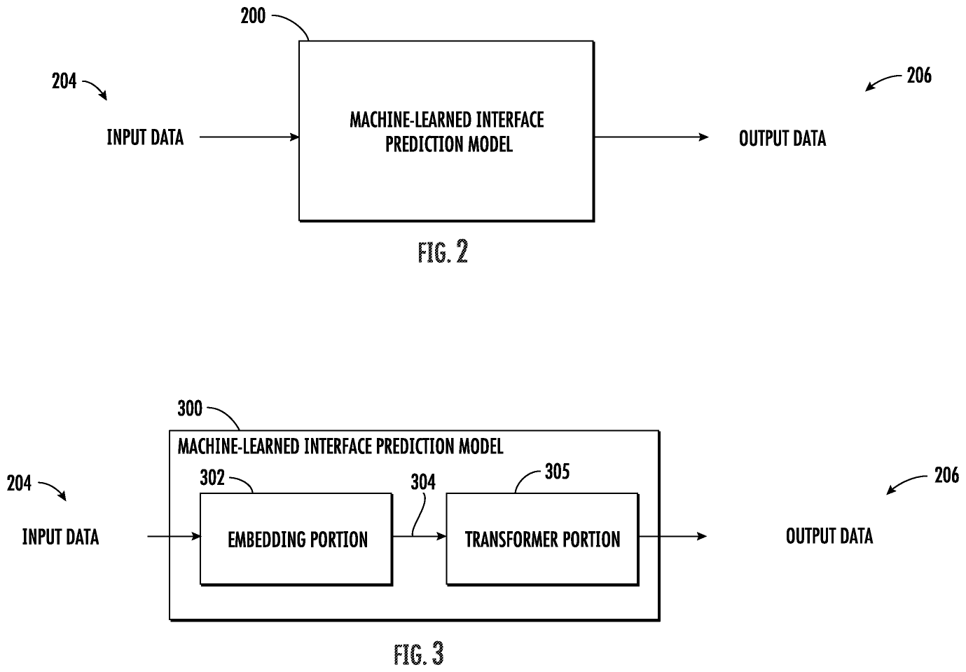

In some implementations, the user computing device 102 can store or include one or more machine-learned interface prediction models 120. For example, the machine-learned interface prediction models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned interface prediction models 120 are discussed with reference to FIGS. 2-3 and 5.

In some implementations, the one or more machine-learned interface prediction models 120 can be received from the server computing system 130 over network 180, stored in the user computing device memory 114, and then used or otherwise implemented by the one or more processors 112. In some implementations, the user computing device 102 can implement multiple parallel instances of a single machine-learned interface prediction model 120 (e.g., to perform parallel interface prediction across multiple instances of the machine-learned interface prediction model).

More particularly, interface data descriptive of a user interface can be obtained (e.g., a user interface presented by an application and/or operating system of the user computing device 102, etc.) at the user computing device 102 . The user interface can include a plurality of user interface elements (e.g., icon(s), interactable button(s), image(s), textual content, etc.). The interface data can include structural data (e.g., metadata indicative of the position(s) of interface element(s), etc.) and an interface image that depicts the user interface. A plurality of intermediate embeddings can be determined based on the structural data, the one or more interface images, and/or textual content depicted in the one or more interface images (e.g., using text recognition models (OCR), etc.). These intermediate embeddings can be processed with a machine-learned interface prediction model to obtain one or more user interface embeddings. Based on the one or more user interface embeddings, a pre-training task can be performed to obtain a pre-training output.

Additionally or alternatively, one or more machine-learned interface prediction models 140 can be included in or otherwise stored and implemented by the server computing system 130 that communicates with the user computing device 102 according to a client-server relationship. For example, the machine-learned interface prediction models 140 can be implemented by the server computing system 130 as a portion of a web service (e.g., an interface prediction service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned interface prediction models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2-3 and 5.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned interface prediction models 120 and/or 140 based on a set of training data 162. The training data 162 can include, for example, a plurality of labeled and/or unlabeled user interfaces (e.g., interface data, etc.).

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs pre-training of a machine-learned interface prediction model according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs interface prediction with a machine-learned interface prediction model according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example machine-learned interface prediction model 200 according to example embodiments of the present disclosure. In some implementations, the machine-learned interface prediction model 200 is trained to receive a set of input data 204 descriptive of a user interface and, as a result of receipt of the input data 204, provide output data 206 that includes one or more interface prediction outputs.

More particularly, the input data 204 can include interface data descriptive of a user interface (e.g., a user interface presented by an application and/or operating system, etc.). The input data 204 can include a plurality of user interface elements (e.g., icon(s), interactable button(s), image(s), textual content, etc.). The interface data can include structural data (e.g., metadata indicative of the position(s) of interface element(s), etc.) and an interface image that depicts the user interface. The machine-learned interface prediction model can process the input data 204 to obtain the output data 206. The output data 206 can include one or more prediction outputs (e.g., search results, classification output(s), etc.).

FIG. 3 depicts a block diagram of an example machine-learned interface prediction model 300 according to example embodiments of the present disclosure. The machine-learned interface prediction model 300 is similar to machine-learned interface prediction model 200 of FIG. 2 except that machine-learned interface prediction model 300 further includes an embedding portion 302 and a transformer portion 305.

More particularly, the input data 204 can first be processed by the embedding portion 302 of the machine-learned interface prediction model 300. As an example, embedding portion 302 can process the interface data (e.g., the structural data, the one or more interface images, etc.) of the input data 204 to obtain a plurality of intermediate embeddings 304. The plurality of intermediate embeddings 304 can be processed with the transformer portion 305 of the machine-learned interface prediction model 300 to obtain output data 206. For example, the plurality of intermediate embeddings 304 can be summed. The summed plurality of intermediate embeddings 304 can be processed with the transformer portion 305 of the machine-learned interface prediction model 300 to obtain output data 206, which can include one or more user interface embeddings U ∈ [symbol] ^{n×d} as represented by:

U=TransformerEncoder(T+P+C), (1)

where T, P, C ∈ [symbol] ^{n×d} and n is the sequence length. Alternatively, or additionally, in some implementations, the output data 206 can include one or more prediction output(s) and/or one or more pre-training outputs.

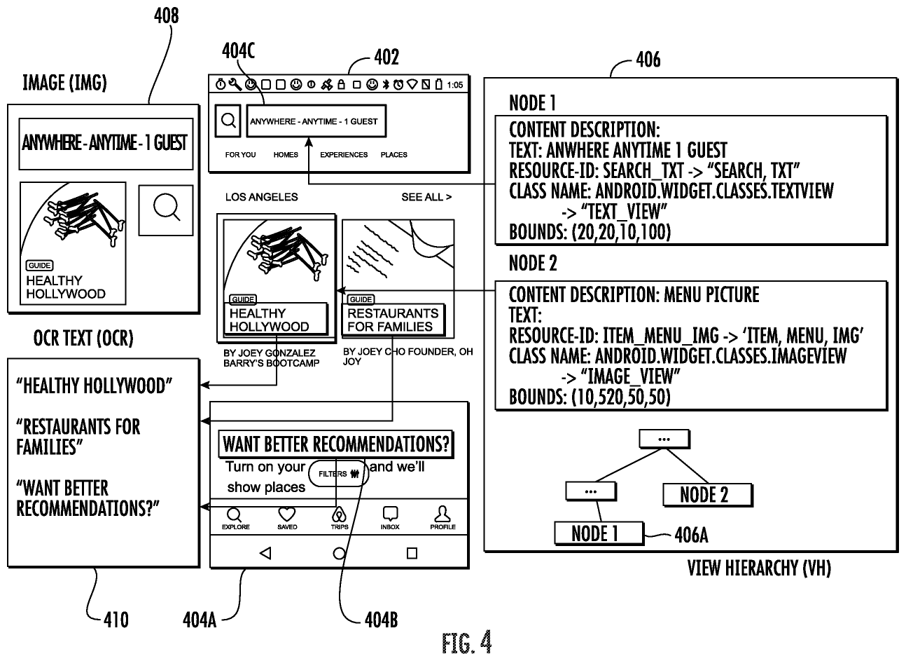

FIG. 4 depicts an example diagram 400 of a user interface according to example embodiments of the present disclosure. More particularly, as depicted, user interface 402 can be a user interface of an application presented on a display device. The user interface can include a plurality of interface elements 404. The interface elements can include icon(s), interactable element(s) (e.g., buttons, etc.), indicator(s), etc. As an example, the plurality of interface elements 404 can include a “back” navigation element 404A. As another example, the plurality of interface elements 404 can include a descriptive element 404B. As yet another example, the plurality of interface elements 404 can include an input field element 404C.

The user interface 402 can include structural data 406. The structural data 406 can indicate positions of the interface elements 404. As an example, the structural data 406 can indicate a size and position the navigation element 404A within the user interface 402 as presented. As another example, the structural data 406 can indicate or otherwise dictate various characteristics of the input field interface element 404C (e.g., font, text size, field size, field position, feedback characteristics (e.g., initiating a force feedback action when receiving input from a user, playing sound(s) when receiving input from a user, etc.), functionality between other application(s) (e.g., allowing use of virtual keyboard application(s), etc.), etc.).

In some implementations, the structural data 406 can be or otherwise include view hierarchy data 406A. The view hierarchy data 406A can include a tree representation of the plurality of interface elements 404. Each node of the tree of the view hierarchy data 406A can describe certain attributes (e.g. bounding box positions, functions, etc.) of a interface element 404. As an example, the view hierarchy data 406A of the structural data 406 can include textual content data associated with visible text included in the input field element 404C included in the user interface 402. As another example, the view hierarchy tree 406A of the structural data 406 can include content descriptor(s) and/or resource-id(s) that can describe functionality (e.g. interface navigation path(s), sharing functionality, etc.) which is generally not provided to users. As another example, the view hierarchy tree 406A of the structural data 406 can include class name data descriptive of function class(es) of application programming interface(s) and/or software tool(s) associated with implementation of the corresponding interface element.

The user interface 402 can include an interface image 408 that depicts at least a portion of the user interface. For example, the one or more interface images 408 can be an image captured as the user interface 402 is displayed on a display device (e.g., capturing using a camera device, a screen capture application, etc.). As depicted, the one or more interface images 408 can include a plurality of portions of the one or more interface images 408. For example, the one or more interface images 408 can be partitioned into portions that correspond to particular interface elements of the user interface 402 (e.g., element 402C, etc.). Additionally, the one or more interface images 408 can additionally depict textual content 410. The textual content 410 can be recognized from the one or more interface images using text recognition technique(s) (e.g., optical character recognition, etc.).

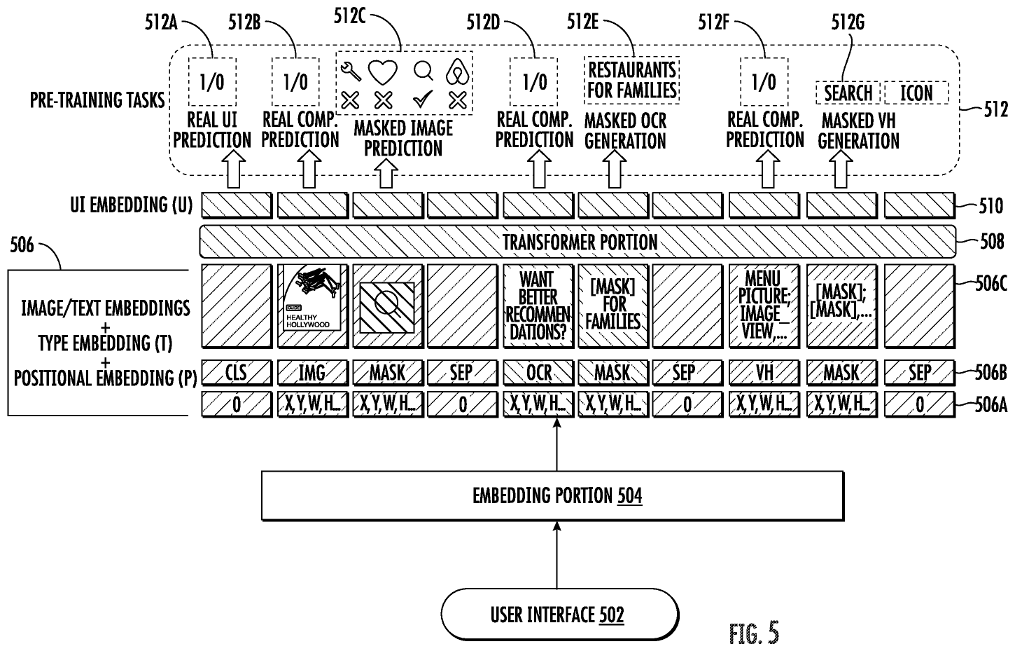

FIG. 5 depicts a data flow diagram for performing pre-training tasks with a machine-learned interface prediction model. More particularly, a user interface 502 (e.g., interface elements, structural data, an interface image, etc.) can be processed with the embedding portion 504 of a machine-learned interface prediction model to obtain intermediate embeddings 506. The intermediate embeddings 506 can be or otherwise include positional embeddings 506A, type embeddings 506B, and image/textual embeddings 506C. As an example, features extracted from the user interface 502 can be linearly projected to obtain the plurality of intermediate embeddings Cᵢ ∈ [symbol] ^{d}, for every i th input with type (i) ∈ {IMG, OCR, VH} using the embedding portion 504 of the machine-learned interface prediction model.

More particularly, in some implementations, the positional embeddings 506A can be determined from structural data of the user interface 502 with the embedding portion 504 of the machine-learned interface prediction model. The positional embeddings 506A can correspond to the one or more positions of the one or more respective interface elements of the user interface 502.

The image/text embeddings 506C can be determined from the one or more interface images. The image/text embeddings 506C embeddings can be respectively associated with at least one interface element of the plurality of interface elements. As an example, one or more portions of the one or more interface images can be determined from the one or more interface images of the user interface 502 (e.g., based on the bounding boxes described by the structural data, etc.). The embedding portion 504 of the machine-learned interface prediction model can process the portion(s) of the one or more interface images of the user interface 502 to obtain the respective image/text embeddings 506C (e.g., using a last spatial average pooling layer, etc.).

The plurality of intermediate embeddings 506 can include type embeddings 502B. The embeddings 502B can respectively indicate a type of embedding for each of the other embeddings of the plurality of intermediate embeddings 506. As an example, to distinguish the various portions of the interface data of the user interface 502, six type tokens 502B can be utilized: IMG, OCR, VH, CLS, SEP, and MASK. In some implementations, the MASK token can be a type of token utilized to increase pre-training accuracy for the machine-learned interface prediction model. For example, a one-hot encoding followed by linear projection can be used to obtain a type embedding 502B, Tᵢ ∈ [symbol] ^{d}, for the iₜₕ component in the sequence where d is the dimension size.

The plurality of intermediate embeddings 506 can be summed, and can be processed with the transformer portion 508 of the machine-learned interface prediction model to obtain one or more user interface embeddings 510. For example, the transformer portion 508 of the machine-learned interface prediction model can process the summated intermediate embeddings 506 to obtain one or more user interface embeddings 510 U ∈ [symbol] ^{n×d} as represented by:

U=TransformerEncoder(T+P+C), (1)

where T, P, C ∈ [symbol] ^{n×d} and n is the sequence length.

Based at least in part on the one or more user interface embeddings 510, one or more pre-training tasks 512 can be performed with a machine-learned interface prediction model (e.g., the transformer portion 508, etc.). As an example, the pre-training task(s) 512 can be or otherwise include an interface prediction task. For example, prior to determining the plurality of intermediate embeddings 506, one or more of the plurality of interface elements of the user interface 502 can be replaced with one or more respective second interface elements of a second user interface that is different than the user interface. As another example, the pre-training task(s) 512 can be or otherwise include an interface element prediction task. As another example, the pre-training task(s) 512 can be or otherwise include an image prediction task. As another example, the pre-training task(s) 512 can be or otherwise include a search retrieval task. As another example, the pre-training task(s) 512 can be or otherwise include an application category classification task. As another example, the pre-training task(s) 512 can be or otherwise include a correspondence prediction task for determining a correspondence between the structural data and the one or more interface images. As another example, the pre-training task(s) 512 can be or otherwise include a relationship prediction task for determining a relationship between a portion of the structural data and an interface element of the plurality of interface elements. As yet another example, the pre-training task(s) 512 can be or otherwise include an interface element category classification task.

### Example Methods

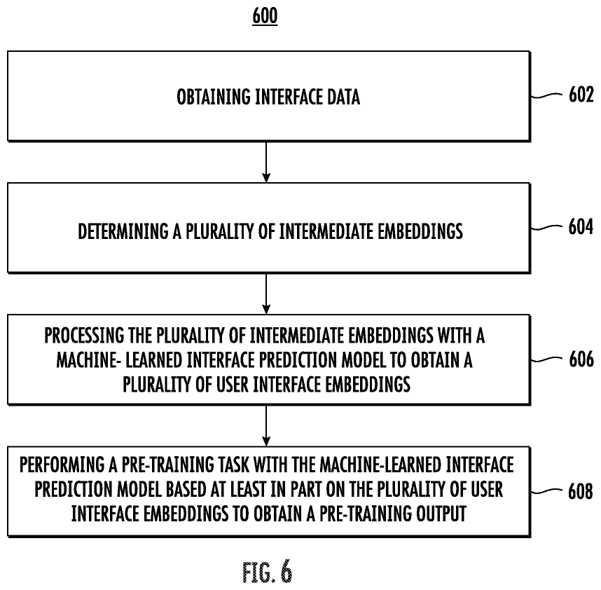

FIG. 6 depicts a flow chart diagram of an example method to perform pre-training of a machine-learned interface prediction model according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain interface data. More particularly, the computing system can obtain interface data descriptive of a user interface comprising a plurality of interface elements. The interface data can include structural data and an interface image depicting the user interface. The structural data can be indicative of one or more positions of one or more respective interface elements of the plurality of interface elements.

At 604, the computing system can determine a plurality of intermediate embeddings. More particularly, the computing system can determine a plurality of intermediate embeddings based at least in part on one or more of the structural data, the one or more interface images, or textual content depicted in the one or more interface images.

At 606, the computing system can process the plurality of intermediate embeddings to obtain one or more user interface embeddings. More particularly, the computing system can process the plurality of intermediate embeddings with a machine-learned interface prediction model to obtain one or more user interface embeddings.

At 608, the computing system can perform a pre-training task. More particularly, the computing system can perform a pre-training task based at least in part on the one or more user interface embeddings to obtain a pre-training output.

At 608 one or multiple pre-training tasks can be performed. Pre-training tasks can be performed in parallel (i.e., jointly) or in series.

In some implementations, the method can further include evaluating, by the computing system, a loss function that evaluates a difference between ground truth data and the pre-training output; and adjusting, by the computing system, one or more parameters of the machine-learned interface prediction model based at least in part on the loss function.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for training and utilization of machine-learned models for user interface prediction, comprising:
obtaining, by a computing system comprising one or more computing devices, interface data descriptive of a single user interface comprising a plurality of interface elements, wherein the interface data comprises one or more interface images depicting the single user interface;
determining, by the computing system, a plurality of intermediate embeddings based at least in part on one or more of the one or more interface images or textual content depicted in the one or more interface images;
processing, by the computing system, the plurality of intermediate embeddings with a machine-learned interface prediction model to obtain one or more user interface embeddings; and
performing, by the computing system, a pre-training task based at least in part on the one or more user interface embeddings to obtain a pre-training output.

2. The computer-implemented method claim 1, wherein the method further comprises:
evaluating, by the computing system, a loss function that evaluates a difference between ground truth data and the pre-training output; and
adjusting, by the computing system, one or more parameters of the machine-learned interface prediction model based at least in part on the loss function.

3. The computer-implemented method of claim 1, wherein:
prior to determining the plurality of intermediate embeddings, the method comprises replacing, by the computing system, one or more of the plurality of interface elements with one or more respective second interface elements of a second user interface different than the single user interface; and
performing the one or more pre-training tasks comprises processing, by the computing system, the one or more user interface embeddings with the machine-learned interface prediction model or a separate pre-training prediction head to obtain the pre-training output, wherein the pre-training output is configured to indicate whether the single user interface is an unmodified user interface.

4. The computer-implemented method of claim 3, wherein the pre-training output is further configured to indicate whether each of the plurality of interface elements is an unmodified interface element.

5. The computer-implemented method of claim 1, wherein:
prior to determining the plurality of intelzitediate embeddings, the method comprises masking, by the computing system, one or more portions of the one or more interface images; and
performing the one or more pre-training tasks comprises processing, by the computing system, the one or more user interface embeddings with the machine-learned interface prediction model or a separate pre-training prediction head to obtain the pre-training output, wherein the pre-training output comprises a predicted completion for the one or more portions of the one or more interface images that have been masked, the prediction completion being selected from a pool of candidate images.

6. The computer-implemented method of claim 1, wherein:
prior to determining the plurality of intermediate embeddings, the method comprises masking, by the computing system, one or more portions of the textual content depicted in the one or more interface images; and
performing the pre-training task comprises processing, by the computing system, the one or more user interface embeddings with the machine-learned interface prediction model or a separate pre-training prediction head to obtain the pre-training output, wherein the pre-training output comprises a predicted textual completion for the one or more portions of the textual content depicted in the one or more interface images and that have been masked.

7. The computer-implemented method of claim 1, wherein, prior to determining the plurality of intermediate embeddings, the method comprises masking, by the computing system, one or more portions of structural data indicative of one or more positions of one or more respective interface elements of the plurality of interface elements.

8. The computer-implemented method of claim 7, wherein:
the one or more portions of the structural data are further descriptive of one or more class labels for one or more respective interface elements of the plurality of interface elements; and
performing the one or more pre-training tasks comprises processing, by the computing system, the one or more user interface embeddings with the machine-learned interface prediction model or a separate pre-training prediction head to obtain the pre-training output, wherein the pre-training output comprises one or more predicted class labels for the one or more respective interface elements.

9. The computer-implemented method of claim 7, wherein:
the one or more portions of the structural data further comprise one or more content descriptors for one or more respective interface elements of the plurality of interface elements; and
performing the one or more pre-training tasks comprises processing, by the computing system, the one or more user interface embeddings with the machine-learned interface prediction model or a separate pre-training prediction head to obtain the pre-training output, wherein the pre-training output comprises one or more predicted content descriptors for the one or more respective interface elements.

10. The computer-implemented method of claim 1, wherein the method further comprises:
performing, by the computing system, one or more prediction tasks with the machine-learned interface prediction model based at least in part on the one or more user interface embeddings to obtain one or more respective interface prediction outputs.

11. The computer-implemented method of claim 10, wherein the respective one or more interface prediction outputs comprise at least one of:
a search retrieval output descriptive of one or more retrieved interface elements similar to a query interface element from the plurality of interface elements;
a prediction output indicative of a relationship between a portion of structural data indicative of one or more positions of one or more respective interface elements of the plurality of interface elements and an interface element of the plurality of interface elements;
a prediction output comprising a correspondence value for the structural data and the one or more interface images;
a classification output indicative of an application category for an application associated with the single user interface; or
a classification output indicative of an interface element category for an interface element of the plurality of interface elements.

12. The computer-implemented method of claim 1, wherein the plurality of intermediate embeddings comprises one or more image embeddings, one or more textual embeddings, and one or more positional embeddings.

13. The computer-implemented method of claim 12, wherein determining the plurality of intermediate embeddings comprises:
determining, by the computing system, the one or more image embeddings from the one or more interface images, wherein the one or more image embeddings are respectively associated with at least one interface element of the plurality of interface elements; and
determining, by the computing system based at least in part on the interface data, the one or more textual embeddings from the textual content depicted in the one or more interface images.

14. The computer-implemented method of claim 1, wherein:
determining the plurality of intermediate embeddings comprises processing, by the computing system, the one or more interface images or textual content depicted in the one or more interface images with an embedding portion of the machine-learned interface prediction model to obtain the plurality of intermediate embeddings; and
processing the plurality of intermediate embeddings with the machine-learned interface prediction model comprises processing, by the computing system, the plurality of intermediate embeddings with a transformer portion of the machine-learned interface prediction model to obtain the one or more user interface embeddings.

15. A computing system, comprising:
one or more processors;
one or more tangible, non-transitory computer readable media storing computer-readable instructions that store a machine-learned interface prediction model configured to generate learned representations for user interfaces, the machine-learned interface prediction model having been trained by performance of operations, the operations comprising:
obtaining interface data descriptive of a single user interface comprising a plurality of interface elements, wherein the interface data comprises an interface image depicting the single user interface;
determining a plurality of intermediate embeddings based at least in part on one or more of the one or more interface images or textual content depicted in the one or more interface images;
processing the plurality of intermediate embeddings with a machine-learned interface prediction model to obtain one or more user interface embeddings; and
performing a pre-training task based at least in part on the one or more user interface embeddings to obtain a pre-training output.

16. The computing system of claim 15, wherein:
prior to determining the plurality of intermediate embeddings, the operations further comprise replacing one or more of the plurality of interface elements with one or more respective second interface elements of a second user interface different than the single user interface; and
performing the pre-training task comprises processing the one or more user interface embeddings with the machine-learned interface prediction model or a separate pre-training prediction head to obtain the pre-training output, wherein the pre-training output is configured to indicate whether the single user interface is an unmodified user interface; and
the pre-training output is further configured to indicate whether each of the plurality of interface elements is an unmodified interface element.

17. The computing system of claim 15, wherein:
prior to determining the plurality of intermediate embeddings, the operations further comprise masking one or more portions of the one or more interface images; and
performing the one or more pre-training tasks comprises processing the one or more user interface embeddings with the machine-learned interface prediction model or a separate pre-training prediction head to obtain the pre-training output, wherein the pre-training output comprises a prediction for the one or more portions of the one or more interface images.

18. The computing system of claim 15, wherein:
the operations further comprise performinu one or more prediction tasks with the machine-learned interface prediction model based at least in part on the one or more user interface embeddings to obtain one or more respective interface prediction outputs; and
the one or more interface prediction outputs comprise at least one of:
a search retrieval output descriptive of one or more retrieved interface elements similar to a query interface element from the plurality of interface elements;
a prediction output indicative of a relationship between a portion of structural data indicative of one or more positions of one or more respective interface elements of the plurality of interface elements and an interface element of the plurality of interface elements;
a prediction output comprising a correspondence value for the structural data and the one or more interface images;
a classification output indicative of an application category for an application associated with the single user interface; or
a classification output indicative of an interface element category for an interface element of the plurality of interface elements.

19. The computing system of claim 15, wherein:
determining the plurality of intermediate embeddings comprises processing one or more of the one or more interface images or textual content depicted in the one or more interface images with an embedding portion of the machine-learned interface prediction model to obtain the plurality of intermediate embeddings; and
processing the plurality of intermediate embeddings with the machine-learned interface prediction model comprises processing the plurality of intermediate embeddings with a transformer portion of the machine-learned interface prediction model to obtain the one or more user interface embeddings.

20. One or more tangible, non-transitory computer readable media storing computer-readable instructions that when executed by one or more processors cause the one or more processors to perform operations, the operations comprising:
obtaining interface data descriptive of a single user interface comprising a plurality of interface elements, wherein the interface data comprises structural data and an interface image depicting the single user interface, wherein the structural data is indicative of one or more positions of one or more respective interface elements of the plurality of interface elements;
determining a plurality of intermediate embeddings based at least in part on one or more of the structural data, the one or more interface images, or textual content depicted in the one or more interface images;
processing the plurality of intermediate embeddings with a machine-learned interface prediction model to obtain one or more user interface embeddings; and
performing a pre-training task based at least in part on the one or more user interface embeddings to obtain a pre-training output.
